(19) United States
(12) Patent Application Publication
(10) Pub. No.: US 2025/0128225 A1
(43) Pub. Date: Apr. 24, 2025

(54) REACTOR FIN INSERT DESIGN

(71) Applicants: Lawrence Livermore National Security, LLC, Livemore, CA (US); OxEon Energy, LLC, Nirth Sait Lake, UT (US)

(72) Inventors: Jorge Luis Barrera Cruz, Livermore, CA (US); Joseph Jay Hartvigsen, North Sait Lake, UT (US)

(21) Appl. No.: 18/806,565

(22) Filed: Aug. 15, 2024

Related U.S. Application Data
(60) Provisional application No. 63/545,326, filed on Oct. 23, 2023.

(51) Int. Cl. B01J 8/06

(52) U.S. Cl. CPC B01J 8/067; B01J 2208/065

(57) ABSTRACT

In one general approach, a heat conducting insert for a reactor includes a center portion, a cross member extending outwardly from the center portion in a radial direction, and at least two branches extending outwardly from the cross member and away from the center portion. Each of the branches has an outer portion extending laterally from a distal end of the respective branch along a portion of an imaginary semicircle. In another general approach, a heat conducting insert for a reactor includes a center portion, a cross member, an outer portion extending laterally from a distal end of the cross member along a portion of an imaginary semicircle, and at least two branches extending outwardly from the cross member from a location on the cross member located between the center portion and the outer portion, wherein distal ends of the branches extend toward, but do not extend to, the semicircle.

### RELATED APPLICATIONS

This application claims priority to U.S. Provisional Patent Application No. 63/545,326 filed Oct. 23, 2023, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to thermal control in flow reactors, and more particularly, this invention relates to fin insert designs for flow reactors.

### BACKGROUND

Most oil wells co-produce methane and natural gas liquids. These resources are typically flared, owing to the economic and logistical challenges of processing and transporting the gas to market. Intentional flaring of gas is a recognized environmental threat, and some countries are already enforcing prohibitions on flaring associated gas. Furthermore, minimizing the emission of greenhouse gases, and particularly carbon dioxide, is critical to reaching some climate targets and avoiding the gravest impacts from global warming. Many of these efforts are centered around decarbonization via electrification with carbon-free renewable energy sources such as solar, wind, etc. While this has led to significant reductions in CO₂ emissions, several challenges remain. The intermittency of renewable energy sources requires economically viable, large-scale energy storage technologies to aid with load balancing and to ensure electric grid stability. Additionally, there are still industrial sectors such as shipping and aviation which are significant sources of CO₂ emissions, but which are not easily coupled to electrical energy. Chemical manufacturing is especially challenging, as carbonaceous materials are a principal feedstock.

Liquid fuels and feedstocks are currently indispensable components of the global economy. Their sustainable production from atmospheric CO₂ through carbon recycling technologies would augment decarbonization efforts and further reduce emissions. Storing electrical energy in the form of liquid fuels would enable integration of difficult-to-decarbonize sectors with renewables while simultaneously addressing long term storage needs.

Fischer-Tropsch (FT) processes include a collection of chemical reactions which convert mixtures of carbon monoxide and hydrogen into liquid hydrocarbons in the presence of metal catalysts. These reactions generally occur at temperatures in a range of about 150° C. to about 300° C. (e.g., about 302° F. to about 572° F.) and at pressures of one to several tens of atmospheres. In the conventional implementations, carbon monoxide and hydrogen, the feedstocks for FT processes, are produced from coal, natural gas, biomass, etc., in a process known as gasification. The FT process typically converts these gases into synthetic lubrication oils and synthetic fuels.

The FT process provides an opportunity to convert this associated gas to high value liquid hydrocarbon fuels, which are storable and transportable. The FT reactor can also produce liquid fuels from renewable electric power whereby hydrogen (or syngas from carbon dioxide and steam) is produced by electrolysis rather than directly from waste fossil fuels. Thus, efforts to improve performance of FT reactors can potentially help mitigate climate change by reducing toxic waste and accelerate the adoption of renewable power alternatives by creating more efficient designs.

Fuel synthesis by the FT reaction is highly exothermic and the reaction rate increases exponentially with temperature. To prevent autothermal runaway, conventional fixed-bed FT reactors use a large number of small diameter catalyst-containing tubes for reaction temperature control. The number of tubes required for a given production rate is inversely proportional to the tube diameter squared, while the reactor cost is proportional to the number of tubes. The design requirement for reactors to be built using many small catalyst tubes makes the capacity-specific cost of FT reactors so high that large plants are required to achieve economics of scale.

### SUMMARY

In one general approach, a heat conducting insert for a reactor includes a center portion, a cross member extending outwardly from the center portion in a radial direction, and at least two branches extending outwardly from the cross member and away from the center portion. Each of the branches has an outer portion extending laterally from a distal end of the respective branch along a portion of an imaginary semicircle.

In another general approach, a heat conducting insert for a reactor includes a center portion, a cross member extending outwardly from the center portion in a radial direction, an outer portion extending laterally from a distal end of the cross member along a portion of an imaginary semicircle, and at least two branches extending outwardly from the cross member from a location on the cross member located between the center portion and the outer portion. The branches extend away from each other and toward the imaginary semicircle. Distal ends of the branches do not extend to the semicircle.

In another general approach, a method for designing a heat conducting insert for a reactor includes selecting an initial geometry of an insert, defining physical characteristics of the insert, selecting algorithmic parameters for use in optimizing the insert geometry, generating a mesh representing the insert in the initial geometry, and morphing the mesh in an iterative process that considers the physical characteristics of the insert to optimize heat transfer provided by the insert.

### BRIEF DESCRIPTION OF THE DRAWINGS

FIG. 1A is an optimized design of one-half of a fin, in accordance with one aspect of the present disclosure.

FIG. 1B depicts an optimized design including the fin shown in FIG. 1A, in accordance with one aspect of the present disclosure.

FIG. 2A is an optimized design of one-half of a fin, in accordance with one aspect of the present disclosure.

FIG. 2B depicts an optimized design including the fin shown in FIG. 2A, in accordance with one aspect of the present disclosure.

FIG. 2C depicts a three-dimensional optimized design including the fin shown in FIG. 2A, in accordance with one aspect of the present disclosure.

FIG. 2D depicts a cross section of a reactor, in accordance with one aspect of the present disclosure.

FIG. 2E depicts a perspective cross section of the reactor of FIG. 2D, in accordance with one aspect of the present disclosure.

FIG. 3 includes a representation of a problem domain separating the design subdomain and non-design subdomain, in accordance with one aspect of the present disclosure.

FIG. 4 is a table of bulk material properties, in accordance with one aspect of the present disclosure.

FIG. 5 is a table of optimization problem formulation parameters, in accordance with one aspect of the present disclosure.

FIG. 6 is a table of geometric and temperature constraints, in accordance with one aspect of the present disclosure.

FIG. 7 includes charts depicting performance of optimal designs, in accordance with one aspect of the present disclosure.

FIG. 8 includes reactor optimal designs for each prescribed temperature, in accordance with one aspect of the present disclosure.

FIG. 9 depicts a heat conducting fin insert for a reactor, in accordance with one shape optimization problem configuration that enforces ten branches extending to the pipe.

FIG. 10 depicts a heat conducting fin insert for a reactor, in accordance with one shape optimization problem configuration that enforces fifteen branches extending to the pipe.

FIG. 11 depicts a heat conducting fin insert for a reactor, in accordance with one shape optimization problem configuration that enforces eight branches extending to the pipe.

FIG. 12 a conceptual graph representing a thermal management shape optimization problem, in accordance with one approach.

FIG. 13 depicts a mesh of the design domain, in accordance with one approach.

FIG. 14 depicts models according to a previous process and the new methodology disclosed herein, in accordance with one approach.

FIGS. 15-19 depict optimization examples, in accordance with exemplary approaches.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred fin inserts of various designs for flow reactors such as Fischer-Tropsch reactors, as well as methodology for designing such fin inserts, in accordance with various aspects of the present invention. The terms “fin insert,” “insert,” and “heat conducting insert” are used interchangeably herein and refer to the same thing.

In one general approach, a heat conducting insert for a reactor includes a center portion; a cross member extending outwardly from the center portion in a radial direction; and at least two branches extending outwardly from the cross member and away from the center portion. Each of the branches has an outer portion extending laterally from a distal end of the respective branch along a portion of an imaginary semicircle.

In another general approach, a heat conducting insert for a reactor includes a center portion; a cross member extending outwardly from the center portion in a radial direction; an outer portion extending laterally from a distal end of the cross member along a portion of an imaginary semicircle; and at least two branches extending outwardly from the cross member from a location on the cross member located between the center portion and the outer portion, the branches extending away from each other and toward the imaginary semicircle, wherein distal ends of the branches do not extend to the semicircle.

In another general approach, a method for designing a heat conducting insert for a reactor includes selecting an initial geometry of an insert; defining physical characteristics of the insert; selecting algorithmic parameters for use in optimizing the insert geometry; generating a mesh representing the insert in the initial geometry; and morphing the mesh in an iterative process that considers the physical characteristics of the insert to optimize heat transfer provided by the insert.

Recent efforts in mitigating climate change have accelerated the development of new technologies for a safer and more sustainable future. Fischer-Tropsch (FT) reactors contribute to this goal by producing high-value liquid hydrocarbon fuels from energy that is currently wasted in most oil wells. Furthermore, FT reactors reduce CO₂ emissions and flaring of coproduced methane. There remains a desire to improve the design of FT reactors for enabling energy savings in manufacturing and energy conversion processes through the implementation of modular, transportable systems.

Fischer-Tropsch processes involve a series of chemical reactions that produce a variety of hydrocarbons. Hydrocarbons, according to various aspects of the present disclosure, may include any compound of hydrogen and carbon. Exemplary hydrocarbons include methane, ethane, propane, butane, pentane, hexane, etc. Hydrocarbons may include any alkanes, alkenes, alkynes, aromatic hydrocarbons, etc., or any combination thereof, as would become apparent to one having ordinary skill in the art upon reading the present disclosure.

The produced hydrocarbons may be synthetic fuel in the form of a readily transportable and relatively stable energy storage medium. In exemplary processes, the resulting synthetic fuel is a mixture of hydrocarbons. In preferred aspects, the resulting synthetic fuel primarily comprises n-paraffins having lengths in the range of C5 to C40 in length. A two-part product collection step of the mixture may include condensing the longer hydrocarbon chains at a higher temperature and separating the longer hydrocarbon chains from relatively shorter chains and any produced water.

The relatively longer hydrocarbon chains (e.g., hydrocarbon chains of length C20 to C40) form a solid at room temperature (e.g., FT paraffin wax). The relatively shorter hydrocarbon chains (e.g., hydrocarbon chains of length C5 to C20) form a liquid at room temperature (e.g., FT oil). Due to the stoichiometry of the reaction, a byproduct of water, approximately two-parts water to one-part fuel by weight, is also produced from the process and is separated out. For preferential production of wax or oil, operating conditions of the FT reactor can be optimized to promote shorter or longer hydrocarbon chain growth, in a manner which would be determinable by one having ordinary skill in the art.

Historically, FT technology has been focused on large scale, fixed-site plants. As presented herein, smaller-scale, transportable solutions are optimally designed to help capture distributed resources. Various aspects of the present disclosure improve upon the performance of flow reactors such as tubular FT reactors and similar systems characterized by thermo-catalytic reactions. At least some of the aspects described herein may be used with thermo-catalytic reactors of many different types, as would become apparent to one having ordinary skill in the art upon reading the present disclosure. In other approaches, at least some aspects as described herein may be used with other porous reactors where heat management is an important consideration. FT reactors are an exemplary implementation of the disclosed concepts, and the present disclosure should not be deemed to be limited thereto, unless otherwise noted herein.

For example, reactor designs implementing at least some of the aspects described herein may refer to the spatial arrangement of fin inserts encompassing a catalyst matrix encased in a tubular shell, e.g., pipe. The performance of tubular FT reactors and similar systems characterized by thermo-catalytic reactions may be improved by designing appropriate layouts of thermally conductive pathways immersed in a catalyst matrix. The systematic design of such layouts requires appropriate formulations of heat management metrics, as well as advanced design tools that assimilate manufacturing constraints. Due to these challenging requirements, conventional reactor designs have not addressed these complex engineering problems.

In various aspects, the systematic design optimization approach described herein finds the spatial arrangement of optimal fin inserts encompassing a catalyst matrix by formulating the optimization problem such that the heat generated in the systems is maximized while keeping the maximum temperature under a threshold.

Manufacturability constraints considered include limiting the minimum length scale of optimized designs and explicitly enforcing catalyst or fin insert material in regions of the design. The optimization approach is used to study the effect of the number and the spatial arrangement of the fin inserts and operating temperatures on the performance of the system.

Fin inserts as described herein may comprise any material, depending on the intended application of the reactor comprising the fin inserts, as would be determinable by one having ordinary skill in the art. Metals are preferred due to their relatively higher coefficients of thermal conductivity, workability (e.g., extrudability, castability), etc. For example, FT reactors may utilize aluminum fin inserts, in at least some approaches. Other approaches may utilize ceramics, etc.

Various aspects of the present disclosure describe fin insert designs used for thermo-catalytic reactions which occur in various classes of energy systems, including FT reactors. These optimal fin inserts provide additional thermally conductive pathways in a catalyst matrix to achieve better heat management, thereby increasing performance. Two-dimensional layouts were obtained using a systematic design optimization tool that realizes designs via a fictitious density field. The physical analysis of the system was computed using information comprising response functions derived from experimental data, geometry of design domain, manufacturability, operating temperature constraints, etc. The two-dimensional layouts of the fin inserts may encompass a catalyst matrix and be encased by tubular pipe (e.g., a steel pipe), in at least some approaches.

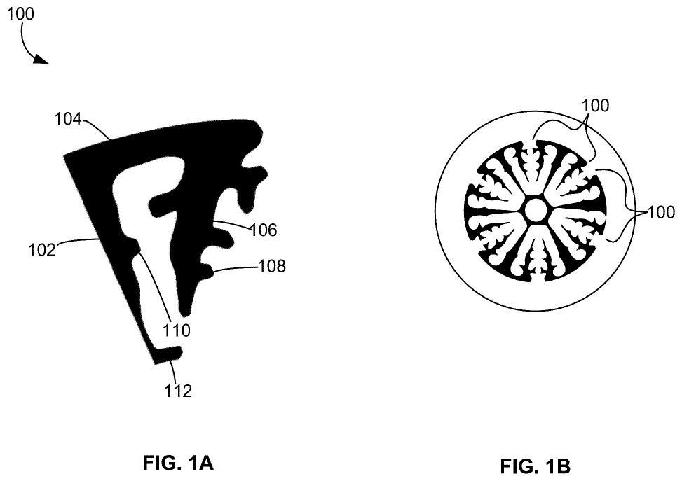

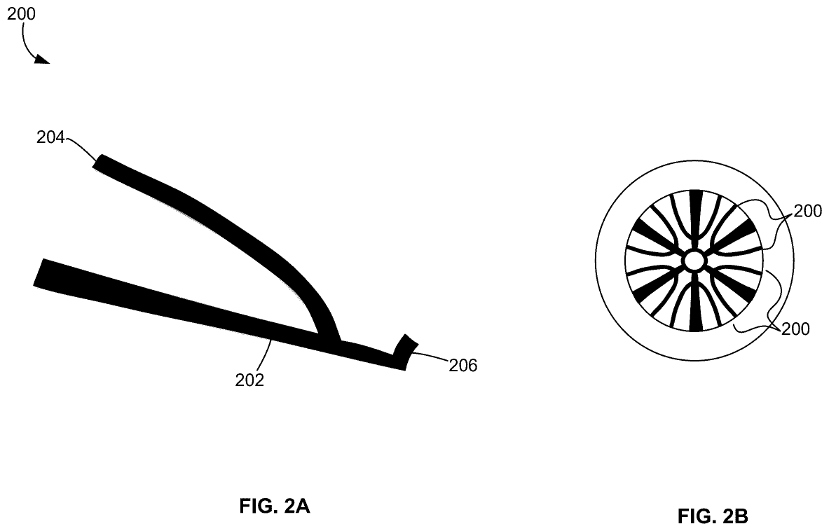

FIG. 1A depicts an optimized design of one-half of a fin 100 in accordance with one aspect of the present invention. As an option, the present fin 100 may be implemented in conjunction with features from any other approaches listed herein, such as those described with reference to the other FIGS. Of course, however, such a fin 100 and others presented herein may be used in various applications and/or in permutations which may or may not be specifically described in the illustrative approaches listed herein. Further, the fin 100 presented herein may be used in any desired environment.

FIG. 1A depicts an optimized design of one-half of a fin 100 having a cross member 102 and an outer portion 104 extending laterally from a distal end of the cross member 102. As shown, the outer portion 104 comprises branches 106 extending from an inner surface thereof. Each branch includes protrusions 108 extending therefrom. The cross member 102 additionally comprises a relatively short extension 110 centrally located along the cross member 102. A portion of the center portion 112 is also shown.

FIG. 1B depicts an optimized design including the fin 100 shown in FIG. 1A. As an option, the present fin 100 may be implemented in conjunction with features from any other approaches listed herein, such as those described with reference to the other FIGS. Of course, however, such a fin 100 and others presented herein may be used in various applications and/or in permutations which may or may not be specifically described in the illustrative approaches listed herein. Further, the fin 100 presented herein may be used in any desired environment.

As shown, the portion of the fin 100 shown in FIG. 1A is reflected to form a complete fin 100. Fin 100 is replicated around the center portion of the insert. The insert includes six fins 100 in this exemplary aspect. The shown measurements are provided by way of example only and should not be interpreted as limiting.

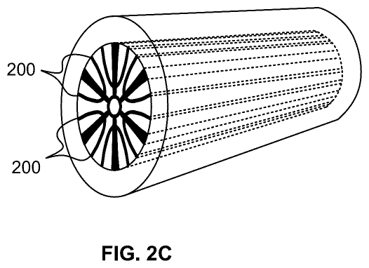

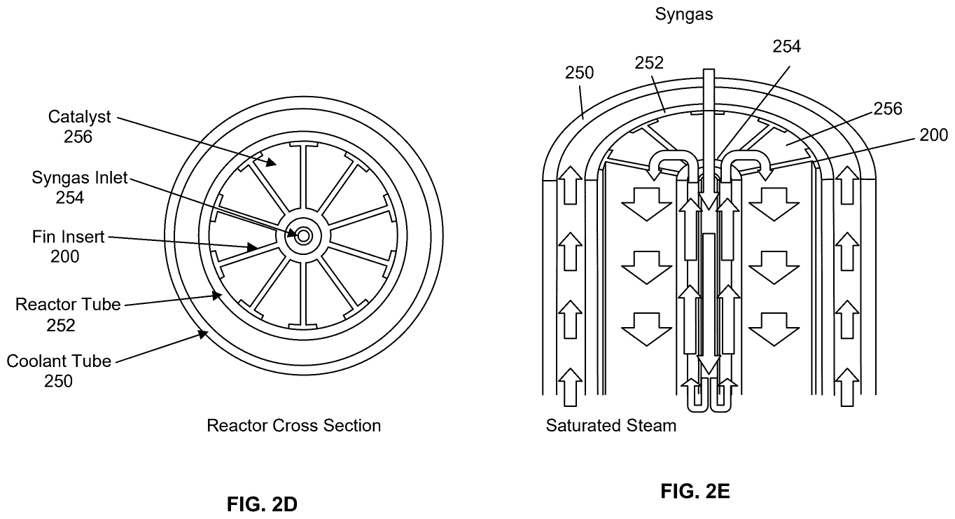

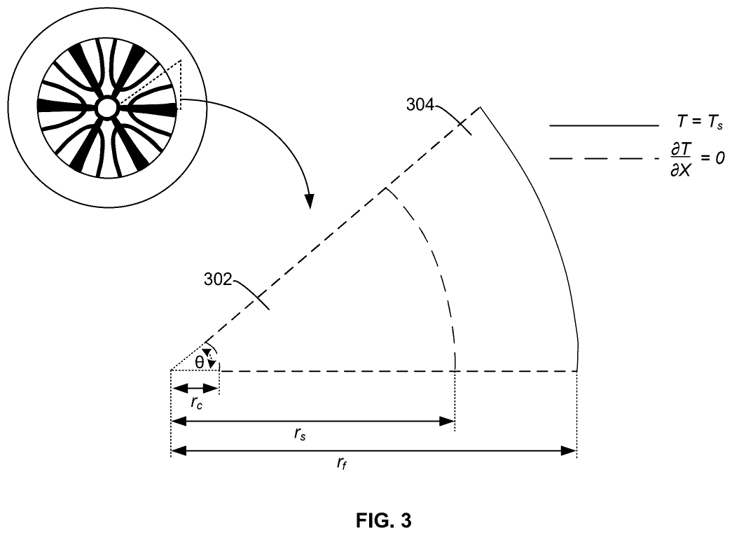

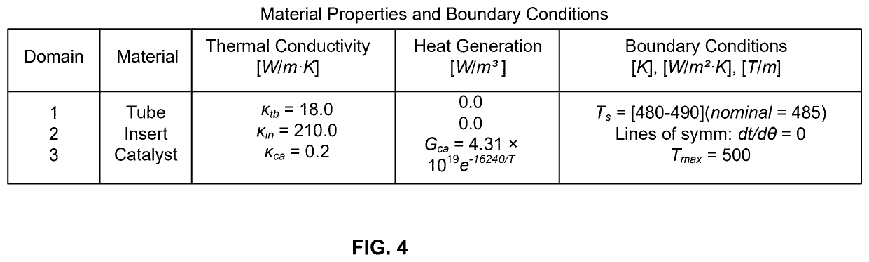

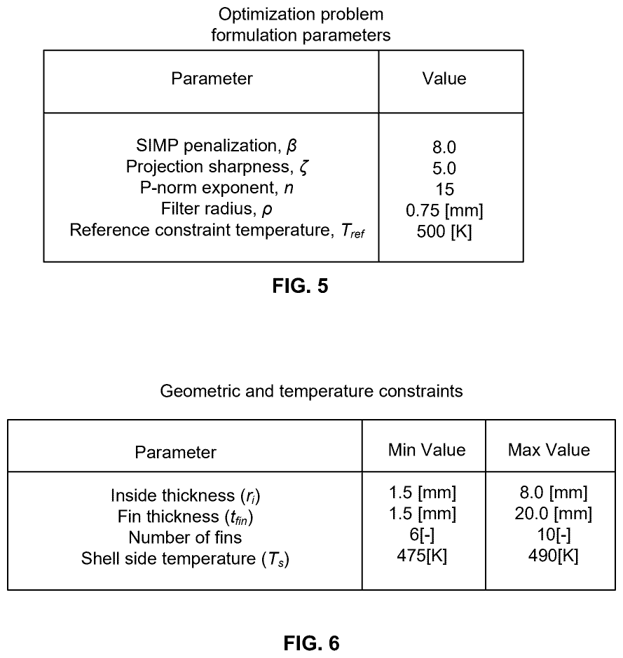

FIG. 2A depicts an optimized design of one-half of a fin 200, in accordance with one aspect of the present invention. As an option, the present fin 200 may be implemented in conjunction with features from any other approach listed herein, such as those described with reference to the other FIGS. Of course, however, such a fin 200 and others presented herein may be used in various applications and/or in permutations which may or may not be specifically described in the illustrative approaches listed herein. Further, the fin 200 presented herein may be used in any desired environment.

As shown, the cross member 202 comprises a relatively long extension 204 extending from an inner surface thereof. A portion of the center portion 206 is also shown.

FIG. 2B depicts an optimized design including the fin 200 shown in FIG. 2A. As shown in FIG. 2B, the portion of the fin 200 shown in FIG. 2A is reflected to form a complete fin 200. Fin 200 is replicated around the center portion of the insert. The insert includes six fins 200 in this exemplary aspect.

FIG. 2C depicts an optimized design including the fin 200 shown in FIGS. 2A-2B, in accordance with one approach. The optimized configuration of FIG. 2C uses a simplified design approach with restricted freedom in shape changes. As shown, the center portion design enables the center portion to be resiliently deformable. A notch may be provided along the center portion to enable the center portion to reversibly compress for temporarily reducing a circumference of the insert.

A cross section (e.g., cross sectional profile) as used herein refers to the cross section along plane which is perpendicular to the longitudinal axis of the product, the insert, the insert in combination with a reactor tube, etc., and the view of said cross section is taken along the longitudinal axis. The longitudinal axis may be parallel to the direction of extrusion of the product.

A product, according to various aspects of the present disclosure, may include a heat conducting insert for a reactor. In various aspects, the insert preferably comprises an elongated center portion and at least one cross member extending outwardly from the center portion. The insert comprises an outer portion extending laterally from a distal end of the cross member. In preferred aspects, the center portion, the cross member, and the outer portion are part of a monolithic, extruded structure, and may be formed by a conventional extrusion process. The monolithic, extruded structure preferably has physical characteristics of extrusion. Physical characteristics of extrusion may include the structure having no seams between the portions/cross member(s), a consistent cross-sectional profile along the longitudinal axis thereof, substantially smooth surface finish (e.g., thereby minimizing post-processing machining), elongated grain structure in the direction of the material, etc.

In at least some aspects, at least a portion of the center portion (e.g., a partial circumference of the center portion), the cross member, and at least a portion of the outer portion are collectively referred to as a “fin” of the insert and/or a “fin insert.”

In various approaches, the insert includes a plurality of cross members extending outwardly from the center portion. In at least some exemplary aspects, the plurality of cross members extending outwardly from the center portion are analogous to a hub and spoke design, as would become apparent to one having ordinary skill in the art.

In some aspects, the insert includes a plurality of cross members extending outwardly from a common center portion in a symmetrical manner. For example, the cross members may have substantially the same cross sectional profile (e.g., a cross sectional profile of the cross member is repeated for each cross member in the plurality of cross members). Similarly, the design of a fin comprising at least a portion of the center portion, the cross member, and at least a portion of the outer portion may be repeated around a singular (e.g., imaginary) center point to obtain a design for an insert having a complete center portion (e.g., there are no gaps in the center portion).

In another exemplary aspect, a first cross member may have a reflected cross sectional profile of the cross member positioned adjacent thereto (e.g., a second cross member having the reflected cross sectional profile of the first cross member). The plurality of cross members may alternate between the cross sectional profile of the first cross member and the cross sectional profile of the second cross member. Similarly, the design of a fin comprising at least a portion of the center portion, the cross member, and at least a portion of the outer portion may be reflected in the design. For example, the original fin design in combination with the reflected fin design may form a pair. The pair of fins may be repeated around a singular (e.g., imaginary) center point to obtain a design for an insert having a complete center portion (e.g., there are no gaps in the center portion) such as those shown in FIGS. 1B and 2B.

In at least some approaches, the heat conducting insert comprises an outer portion extending laterally from a distal end of the cross member. The distal end of the cross member is preferably at the opposite end (e.g., a proximal end) of the cross member which is coupled to the center portion. In preferred aspects, the outer portion does not form a continuous perimeter. For example, the insert does not have continuous contact with an imaginary perimeter surrounding the insert. According to some approaches, the imaginary perimeter may be defined by an interior circumference of a reactor tube in which the insert is inserted (e.g., press-fitted). In other aspects, the outer portion forms a continuous perimeter.

In one aspect, a width of the cross member increases therealong from the proximal end thereof toward the distal end thereof. For example, the width of the cross member may taper along the length of the cross member extending from the outer portion toward the center portion. In an alternative aspect, a width of the cross member decreases therealong from the proximal end thereof toward the distal end thereof. In yet further aspects, the width of the cross member may fluctuate therealong from the proximal end thereof toward the distal end thereof. For example, the cross member may appear to be hourglass shaped in some instances.

In at least some aspects, the center portion is resiliently deformable. For example, the center portion is configured to reversibly compress for temporarily reducing a circumference of the insert. The center portion preferably reversibly compresses to enable the insert to be press-fitted into a reactor shell (e.g., a reactor tube). In various aspects, the center portion is continuous along a longitudinal length thereof. A continuous center portion refers to the center portion not being broken and/or capable of serving as a feed pipe for the reactor, as would become apparent to one having ordinary skill in the art upon reading the present disclosure. In other aspects, the center portion is not continuous along a longitudinal length thereof.

According to some aspects, the outer portion has branches extending from an inner surface thereof toward the center portion. The branches have protrusions extending outwardly therefrom. In at least some aspects, the branches have characteristics of tree generation according to various techniques known in the art.

In at least one aspect, the cross member has extensions extending outwardly from the cross member to the inner surface thereof toward the center portion. Extensions on the cross member may extend outwardly therefrom and have characteristics of tree generation.

In at least some approaches, the mass distribution of the insert (e.g., the fin) may be more concentrated (e.g., higher) around the center portion relative to the outer perimeter of the insert.

A reactor, according to at least some aspects described herein, includes a shell (e.g., a reactor tube) and an insert as described in detail above. Dimensions for the diameter of the insert, the shell, the shell in combination with the insert, etc., would be determinable by one having ordinary skill in the art in view of the type of reactor used and/or the intended application. For example, the diameter of the inner center portion may be in a range of about 6.35 mm to about 9.5 mm in some applications. For at least some of the exemplary aspects described herein, a 4″ schedule XXH pipe (4.5″ OD, 3.152″ ID) was used.

### Experimental: Design and Background Information

The optimization problem formulation as described herein maximizes the heat generated in the system (e.g., as a proxy for fuel production) while keeping the maximum temperature under a threshold. In various approaches, the highly exothermic, temperature-dependent reactions in the fuel system of Fischer-Tropsch reactors were simulated using a heat transfer model with an Arrhenius temperature dependence in the volumetric heat generation field. In various approaches, a two-dimensional setup is preferred since the reactor inserts are produced through extrusion. Numerical stability of the system was achieved by adding a smooth Heaviside function to the heat generation expression, which is not typically used in benchmark optimization problems. Material properties and nonlinear behavior of the system were characterized from experimental data. The thermal response was predicted using the finite volumes in an open-source software (e.g., OpenFoam®) and the geometry was realized through density-based topology optimization, namely, the solid isotropic material with penalization method using in-house systematic design codes (e.g., LiDO). Manufacturability constraints were included by limiting the minimum length scale of the converged designs and restricting regions of the design domain. Studies on the number and spatial arrangement of fin inserts and operating temperatures were performed.

Simplified optimization approaches of FT reactors typically generate suboptimal designs due to a relatively narrow design space available to explore. Despite their simplicity, these extrudable inserts were placed inside a reactor tube and tested successfully using both iron and cobalt catalyst materials. The first of its kind reactor worked well for catalysts of moderate activity, which motivated the application of more advanced design approaches to this problem.

There exists a need of a systematic optimization approach to explore a wider design space and for further improvement in performance. However, limitations of commercially available computational analysis and design tools restrict the application of systematic design approaches. Advanced design tools typically require complex derivations associated with both the optimization problem formulation and the mathematical model used to predict the system's response, even when the physics are approximated by a thermal continuum model. In the former, thermal management through enforcing temperature constraints can be formulated in multiple ways, and studies concerning stability of the optimization problem are required. With respect to the latter, the model should capture the complex chemical reactions that transform gas into fuel.

Various aspects of the present disclosure use state-of-the-art computational analysis and design tools to generate the two-dimensional layout of fin inserts in next generation, modular FT reactors. A diffusion model predicts the thermal response, and the complex chemical phenomena occurring in the catalyst are represented by a nonlinear heat source term. The design approach employed relies on a fictitious density field to realize optimal designs. This continuous field is characterized by blurry interfaces and thus, inexact geometry representation by construction. The effect of this inherent fuzziness in both the analysis of the response and extraction of optimal designs is assessed by verifying the performance of the optimal designs against a commercial software.

At least some of the modular FT reactors described herein are composed of concentric steel tubes that encapsulate the FT reaction catalyst (e.g., iron/cobalt). FIGS. 2D and 2E illustrate, by way of example, the configuration of the concentric steel tubes 250, 252, 254. In an exemplary process, feed syngas flows into the innermost tube 254 and through the fixed catalyst bed 256 where it is polymerized into higher value products. An external tube 250 contains saturated steam to control reactor temperature, e.g., to cool the reactor tube 252. One or more highly thermally conductive metallic fin inserts 200 are incorporated for enhancing thermal management of this highly exothermic reaction, as thermal control controls product distribution and reactor stability. To maximize the productivity of the reactors and minimize costs, the fin 200 should contain as little material as possible while still providing sufficient heat conduction from the catalyst 256 to the walls of the inner tube 254. The fins 200 yield thermal conduction pathways, but any material occupied by fin excludes catalyst. Conversely, the low conductivity catalyst 256 ultimately leads to large thermal gradients and lower efficiency reactors. Thus, the central design problem is to determine the fin layout which strikes an optimal balance between these inherently adversarial requirements.

### Experimental: Reactor Design Problem

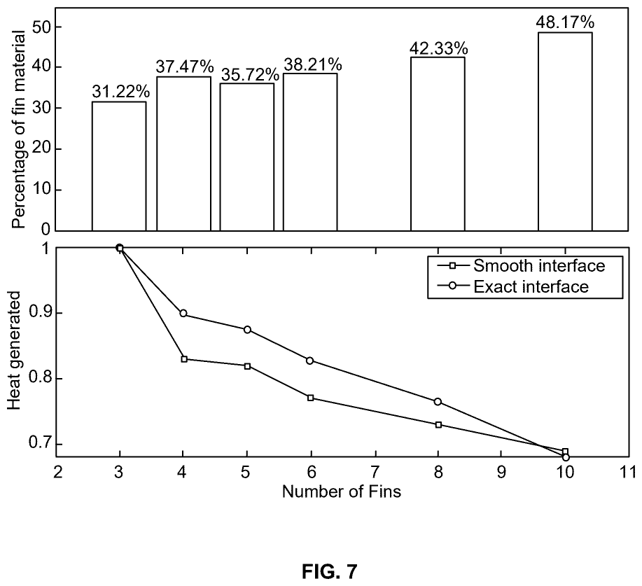

FIG. 3 includes a representation of a problem domain separating the design subdomain 302 and non-design subdomain 304. The FT reactor problem is discretized on a two-dimensional wedge domain. By taking advantage of symmetry conditions, only a portion of the FT reactor is modeled based on the number of prescribed fin inserts. Here, the wedge angle θ is defined as half of the angle between two consecutive fins. The wedge angle θ of the sector controls the angular symmetry of the design and thus the ultimate number of fins. The angle between two consecutive fins is defined as 2θ. The wedge is subdivided into three phases to model the stainless steel circular tube, the aluminum fin insert, and the iron/cobalt catalyst (e.g., pellets) comprising the porous fixed-bed reactor. The central goal of the optimization techniques described herein is to determine the optimal spatial arrangement of aluminum and porous material in the non-design subdomain 304. Hence, only the design subdomain 302 is optimized. The tube geometry remains unchanged, and the exterior of this wedge domain is assumed to contact the saturated steam as described in detail above.

### Design Optimization Approach

The design is optimized using density-based topology optimization, namely the Solid Isotropic Material with Penalization (SIMP). In this method, material properties are penalized by a continuous fictitious density field denoted by γ, which is bounded between 0.0 and 1.0. The aluminum fin corresponds to regions with γ=1.0 while the porous region corresponds to γ=0.0. This field evolves throughout the optimization process to converge into a realizable design, which is constructed using the three-field strategy. These three fields correspond to: the raw fictitious density field, the filtered density field, and the filtered projected density field.

In the three-field approach, a set of design variables, \hat{γ}, also bounded between 0.0 and 1.0, are used to construct γ through filtering and projection. First, the filtering operation is perform using a Helmholtz filter, i.e., by solving the following equation subject to homogeneous Neumann boundary conditions:

$$- {ρ}^{2} {∇}^{2} \tilde{γ} + \tilde{γ} = \hat{γ} , \qquad ( 1 )$$

where ρ represents the filter radius and controls the minimum allowed length scale of the filtered density field, \tilde{γ}. Second, \tilde{γ} is projected using a smoothed Heaviside function:

$$γ = 0.5 + 0.5 \frac{tanh ( ζ ( \tilde{γ} - 1. ) )}{tanh ( ζ )} , \qquad ( 2 )$$

with ζ controlling the projection sharpness. This third (filtered, projected) fictitious density field, herein defined as the design field, γ, is used to parameterize the physical problem and enable topology optimization as described in detail below.

The inner tube is modeled as part of the physical problem, but it is not designed. Hence, the design field is not defined in FIG. 3. The goal of the optimization is to determine the spatial arrangement of fin inserts (γ=1.0) and the catalyst (γ=0.0) in the design subdomain.

### Physical Model

A steady heat diffusion model is employed to model the thermal response of the reactor wedge and determine the temperature field, T:

$$\frac{\partial }{\partial {x}_{i}} ( κ ( γ ) \frac{\partial T}{\partial {x}_{i}} ) + G ( γ , T ) = 0 , \qquad ( 3 )$$

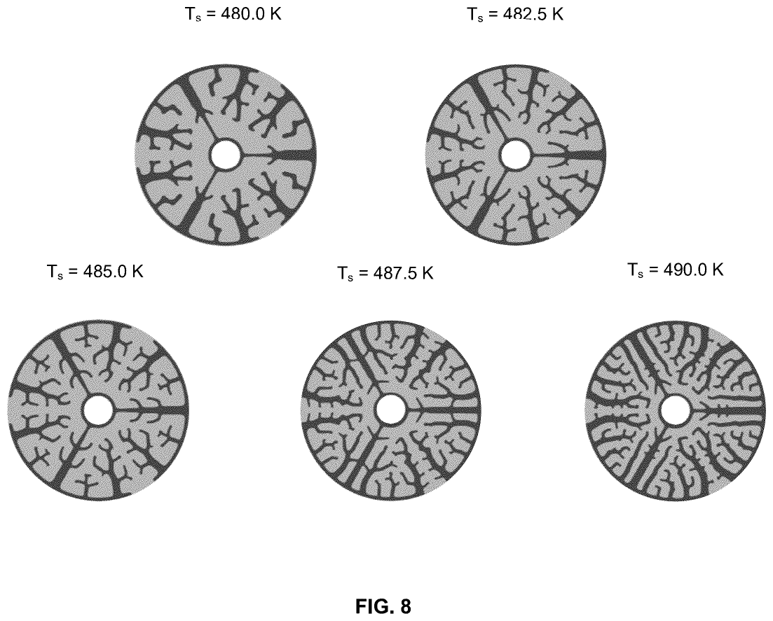

In this boundary value problem, a constant temperature, Tₛ, is prescribed along the outer surface of the inner tube in contact with saturated steam. Adiabatic conditions are prescribed along the three remaining boundaries, n·∇T=0 with n being the outward facing normal to the boundary. The bulk material properties for each phase and boundary conditions are specified in FIG. 4. The outer boundary of the wedge corresponds to the interface between the reactor and an external cooling channel. The latter is not included in the model, as instead it is assumed that the external temperature is prescribed. The outer surface of the tube is set to Tₛ=485 K, unless specified otherwise.

The physical parameters are functions of the design variable (or constant in the case of the tube) and thus, the design variables control which material is being modeled. In Eq. 3, the thermal conductivity is denoted by κ, and is defined as:

$$κ ( γ ) = \{ \begin{matrix}{κ}_{tb} , & ∀ r > {r}_{s} , \\ {κ}_{i n} + ( 1 - {γ}^{β} ) ( {κ}_{c a} - {κ}_{i n} ) , & ∀ r \leq {r}_{s} ,\end{matrix} \qquad ( 4 )$$

Here, [κ_{tb}, κᵢₙ, κ_{ca}] are the bulk material properties for the tube, inserts, and catalyst phases, respectively, and β represents the penalization on intermediate densities. Note that when γ=0.0, the thermal conductivity is equal to the conductivity of the porous material, κ_{ca}. Conversely, when γ=1.0, the conductivity corresponds to the conductivity of the thermal insert, κᵢₙ.

This equation thus provides a smooth interpolation between the two phases. The temperature-dependent heat source term, G, is defined as follows:

$$G ( γ , T ) = \{ \begin{matrix}0 , & ∀ r > {r}_{s} , \\ ( 1 - γ ) \overline{G} ( T ) , & ∀ r \leq {r}_{s} ,\end{matrix} \qquad ( 5 )$$

and thus, linearly interpolates between the aluminum fin, where G=0.0 and no heat is generated, and the porous region, where G=G̅ defined below.

### Heat Generation in the Catalyst

The FT chemistry of the tubular reactors considered in this manuscript consists of the following chemical reactions:

CO+H₂O↔CO₂+H₂

CO+3H₂→CH₄+H₂O

CO+2H₂→(1/n)(CₙH₂ₙ)+H₂O

2CO→C+CO₂ (6)

The first reaction represents the water-gas shift reaction, the second row shows the methanation reaction (i.e., the conversion of carbon monoxide to methane), the third corresponds to the synthesis of C2+ hydrocarbons, and the final row is the Boudouard reaction.

A temperature-dependent exponential heat source term is used to approximate the exotherm of the FT reaction, instead of incorporating Eqs. 6, all products were lumped together and only the consumption of CO in the catalyst is considered. The thermal heat source was defined such that approximately 2.4 liters of fuel per day are produced for every liter of catalyst available. An average heat of reaction of 165 KJ/mol reactive per liter of catalyst was used to obtain an equivalent heat generation of 337 W per liter of catalyst. This resulted in the representative values in the temperature-dependent Arrhenius expression for heat generation in the catalyst subdomain, G_{ca}, in the table of FIG. 4.

To avoid numerical instability, the maximum allowed heat generation for the catalyst is kept constant if the temperature exceeds a threshold T_{G}_{_{ca}}^{max}. A smooth Heaviside function similar to the expression used in Eq. 2 is used here:

$${\overline{G}}_{c a} ( T ) = {G}_{c a} ( T ) + ( {G}_{c a} ( {T}_{{G}_{c a}}^{max} ) - {G}_{c a} ( T ) ) ( 0.5 + 0.5 \frac{tanh ( ζ ( T / {T}_{{G}_{ca}}^{{max}^{- 1.}} ) )}{tanh ( ζ )} ) . \qquad ( 7 )$$

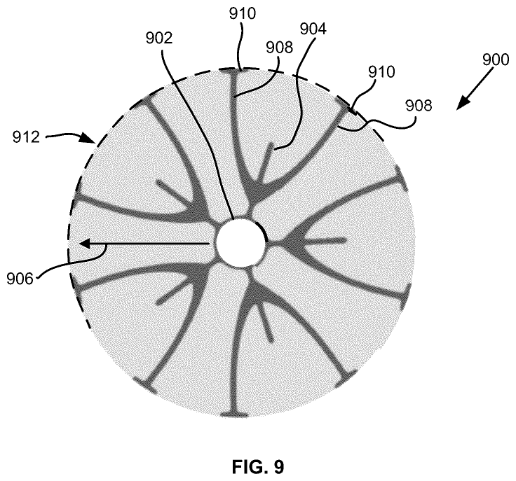

The projection sharpness, ζ, is typically set to a value high enough such that the desired limit of the heat source is enforced (i.e., ζ=[0.1−100]), see the table shown in FIG. 5. Note that this augmented expression is intended to stabilize the computations associated with the solution of the physical analysis but does not compromise accuracy of response so long as T_{G}_{_{ca}}^{max}. In this work, this temperature limit is set to T_{G}_{_{ca}}^{max}=502.5 K.

### Optimization Problem Formulation

The optimization problem includes maximizing the reaction rate in the catalyst, or equivalently the heat generated by the reaction, without exceeding a prescribed maximum temperature. This serves as a proxy for maximizing fuel production while preventing autothermal runaway. The formulation reads:

$$\begin{matrix}max J \\ γ\end{matrix} = 1 / C \int G ( γ , T ) dV \qquad ( 8 )$$

$$s . t . {g}_{T} = {( \frac{\int {( T / {T}_{r e f} )}^{n} d V}{\int d V} )}^{1 / n} - 1 \leq 0 ,$$

where the normalization parameter of the objective is C=∂G(γ₀,T)dV, with γ₀ being the initial design. The exponent n controls the sharpness of the smoothed maximum temperature measure, i.e.,

$${T}_{max} \approx {( \frac{\int {T}^{n} d V}{\int d V} )}^{1 / n} ,$$

see the table of FIG. 5. For large values of n, this constraint tends to T≤T_{ref} and ensures that the temperature does not exceed the reference temperature anywhere in the computational domain. In addition, T_{ref} represents an indirect measure of the maximum allowed temperature. Note this constraint is such that the maximum temperature anywhere in the system is below T_{ref}<T_{G}_{_{ca}}^{max}. Hence, as long as the constraint is satisfied, the heat generated by the heat source will follow the exponential expression for the catalyst, G_{ca}, see the table in FIG. 4. This circumvents any inaccuracies resulting from the threshold expression in Eq. 7 since solutions to the optimization problem stay below the maximum threshold.

Nonlinear programming is employed to update the design and to find optimal layouts for fin inserts. In this gradient-based optimization approach, derivatives of objective and constraint functionals with respect to the design variables are computed using the continuous adjoint method. The optimization problem is solved using the method of moving asymptotes with its standard parameter setting.

### Fabrication Restrictions and Initializations

The geometry was adapted to reflect a design problem subject to symmetry, i.e., 0=180/n_{fins} with n_{fins} being the number of fins. In addition, the vicinity of the external boundary of the design subdomain is assigned fixed design variable to enforce either fin insert or catalyst by construct in such regions.

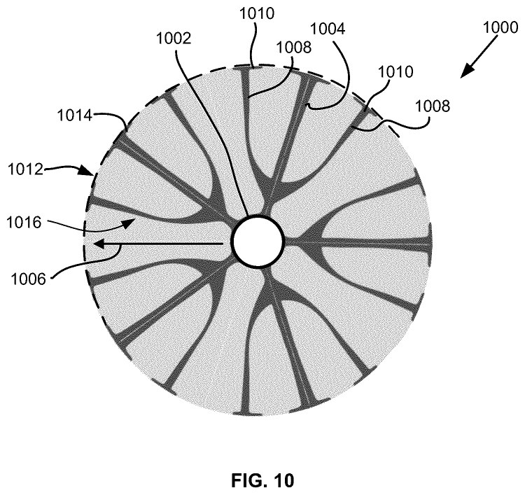

The thickness of this prescribed region along this subdomain is given by the minimum manufacturable feature, t_{fin}, provided in the table shown in FIG. 6. Note that the thickness of the inclined and horizontal boundaries is half of the manufacturability constraint since symmetry is considered across fin inserts. This problem initialization is sufficient to avoid disconnected inserts due to the relatively simple and small design space and because the physics promote continuous designs, i.e., disconnected pieces cannot channel heat to the boundaries, The remaining design field is initialized with a fictious density of 0.5, and changes throughout the optimization process. Optimal designs are further characterized by a minimum manufacturable feature of at least twice the provided filter radius, ρ, in Eq. 3, satisfying the guidelines in the table of FIG. 6.

### Numerical Solution

The physical response of the system is approximated using OpenFoam® via the finite volume method. The nonlinear governing equation is solved by first linearizing the source term. Then, the linearized source term is solved using Geometric Agglomerated Algebraic Multigrid (GAMG) solver with Gauss-Seidel smoother. The linearized source term is updated at each outer loop iteration and iteration continues until convergence under a threshold ϵ<1×10⁻⁷. Note, however, that the findings do not rely on any discretization technique. Alternative numerical methods such as the finite element method, or finite element-based advanced methods, may be used instead without loss of generality.

Designs are realized by a continuous design field. Thus, intermediate densities in the interfaces (i.e., between the catalyst and insert phases) are unavoidable. To quantify inaccuracies in the geometry description, stereolithography (STL) files of the designs are obtained from the design field, γ, by applying a filter that generates an isocontour at γ=0.5. These STL are surface representation files which contain defined boundaries between the fitted meshes and porous catalyst material. They are used an input for body-fitted meshes into a commercial software, i.e., Star-CCM+ (Siemens), to verify their performance using the same material properties and problem setup described herein.

### Experimental: Reactor Design Via Density-Based Topology Optimization

The topology optimization algorithm described above is employed to design FT reactor inserts as a function of the number of fins and the operating temperature.

The fin insert topology generated by the optimization framework reveals an organic structure that concentrations fin material near the inner tube wall and develops into thick branches that travels back to the center of the reactor. The formulation employed imposes a hierarchy of length scales as the large branches further subdivide into numerous thinner branches, Note that the minimum length scale observed is in agreement with the enforced value from the Helmholtz filter. The optimal design also contains a tapering angle leading to thinning of the main branches as they approach the center of the reactor. Importantly, these features are generated automatically and area revealing high performance architecture from non-intuitive portions of the design space.

### Varying the Number of Fins

The formulation of the design problem imposes angular symmetry over a predetermined sector. Equivalently, this imposes a fixed number of fins that fully span from the center of the reactor to the inner tube wall. The impact of this manufacturing constraint on the optimized designs is investigated for n_{fins}=[3, 4, 5, 6, 8, 10].

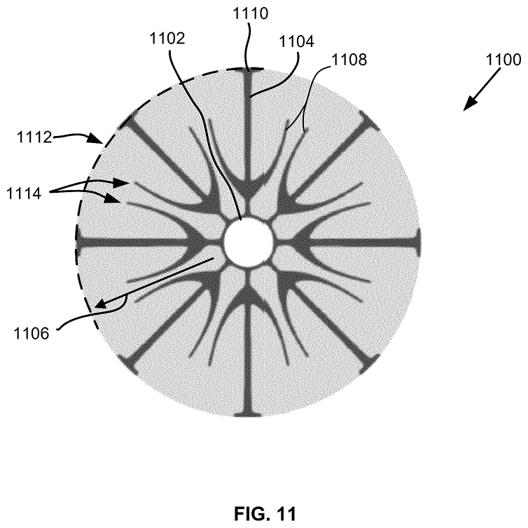

For post-processed optimal designs, the intermediate region has been eliminated by choosing the γ=0.5 and projecting all other values to their closest extremum. In all designs, the fin thickness increases radially, again generating tapered inserts, and generally concentrate the insert material towards the outer circumference of the design domain. The complexity of the fin topologies is considerably reduced for a large numbers of fins. The fins also become thinner as more fins are included. For a large numbers of fins, more inserted fin material is used to satisfy the temperature constraint. Similar fin insert material is used for configurations up to six fins, but significantly more material is used for ten fins. This is counterintuitive and surprising as the additional fins would be expected to further enhance heat transfer. Instead, it appears that including more fins leads to a smaller design domain for the algorithm (i.e., a smaller designable sector) and less opportunity for branching. Indeed, the branching increases dramatically as the number of fins decreases and suggests that hierarchy of scales manages temperature while minimizing material usage. The reactor performance is maximized when the volumetric reaction rate, and hence heat generation, are maximized. This objective function decreases with the number of fins used in the reactor. This is as expected, as the more space devoted to cooling the reactor, the less room there is for the porous catalyst bed driving the reaction. The decay in performance is again attributable to the reduced design freedom from externally imposing architecture via the manufacturing constraint of fin number. Having more fins leads to a reduction in the designable space. Interestingly, using larger numbers of fins more closely resembles conventional architectures, but it is by allowing the algorithm the large latitude to create the designs that the performance is maximized. Alternatively, if large fin numbers are used due to other engineering constraint, e.g., structural integrity, the optimization algorithm still provides a pathway to improve performance. A diminished performance of optimal designs, however, is the expected trade-off to better structural integrity. In the absence of any structural constraint, the reactor includes at least three fins as this maximizes productivity while minimizing fin insert material usage, see FIG. 7 comparing the associated performance values for designs having varying numbers of fins and fin material usage.

### Varying the Operating Temperature

In the modular FT reactors considered, the tube wall temperature, Tₛ, is controlled by adjusting the operating pressure of the saturated steam serving as the coolant on the external surface of the reactor. The nominal temperature, Tₛ=485 K, was used. Nevertheless, during practical operation, this temperature may be adjusted and serves as a process control parameter. To assess the effect of varying this prescribed temperature on the optimal topology and its performance, the high highest performing fin number from the previous section is chosen, n_{fins}=3, and several different surface temperatures are investigated, Tₛ=[480.0 K, 482.5 K, 485.0 K, 487.5 K, 490.0 K]. All other parameters, including the target maximal temperature, T_{ref}=500 K, are unchanged.

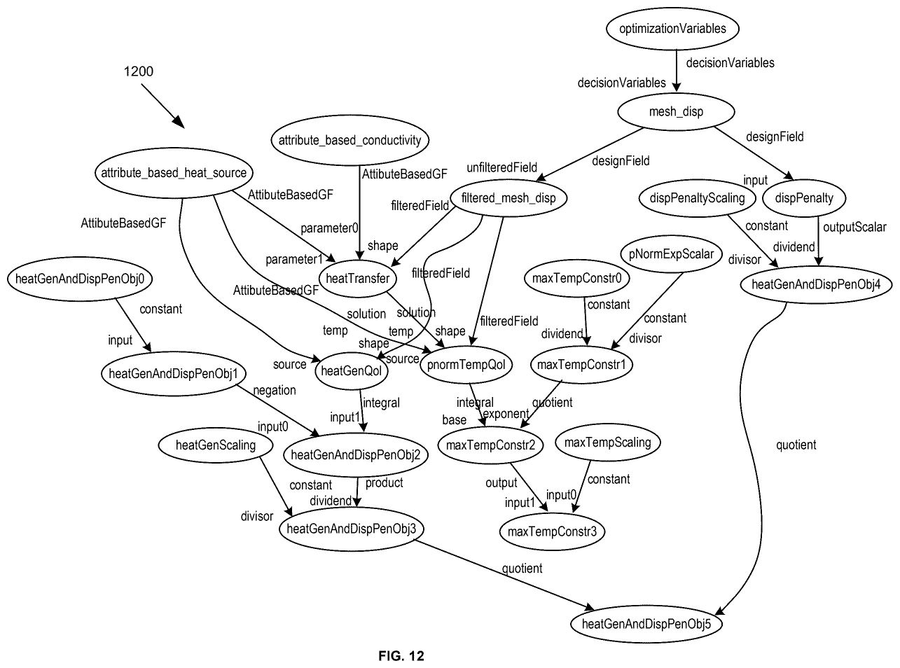

FIG. 8 includes optimal reactor designs for each prescribed temperature. Because of the diminished conduction driving force, more intricate topologies and fin insert material are used as Tₛ increases. The salient features observed earlier persist, as the fins are still hierarchical and taper toward the center of the reactor.

Less conductive fin insert material may be used for the lower external temperatures, this leads to a drop in reactor performance. For Tₛ<485 K, the optimal designs show significantly lower heat generation. Alternatively, for Tₛ>485 K, the topologies of the optimal inserts use progressively more material. These studies suggest that using the optimal design with a three-fin configuration and operation temperature of Tₛ=485 K provides an appropriate balance between performance and material usage.

### Experimental: Conclusions

Optimal designs of modular Fischer-Tropsch reactors were obtained via a systematic design approach that automatically determines the spatial arrangement of highly conductive fin inserts for improved thermal management. A density-based topology optimization algorithm was developed to determine the optimal material layout of the fins within the catalyst matrix for the two-dimensional reactor cross section. The temperature profiles in the reactor were simulated using a simplified but industrially relevant model for heat generation in the fixed porous catalyst bed. This simulation was used to formulate and solve an optimization problem to determine fin architectures which maximize reactor productivity while preventing autothermal runaway. Additionally, several strategies for improving manufacturability of the computer-generated designs were presented. In contrast to traditional trial-and-error methods characterized by expensive iteration, the computer-driven approaches presented herein automates and accelerate the design process. This change in paradigm reveals a systematic methodology that has not previously been explored in the design of fin inserts for FT reactors. Further, the presented studies demonstrated how architectural and processing parameters, such as fin number or operating temperatures, can be incorporated into the design process. The design tools thus play an important role in enhancing exploration of the design space and informing designers of the influence of relevant features that can lead to improved performance. Indeed, this work suggests the importance of hierarchy and fin tapering as important strategies for improving thermal management. These advances are helping to engineer the next generation of modular FT reactor, addressing variable scales of syngas production and ensuring pervasive deployment regardless of site size.

### Fin Designs Optimized for Manufacturability and Thermal Management

Note that though the reactor designs shown in FIGS. 1A-1B and 8 may be near-optimal designs from a thermal management standpoint, their intricate geometry may render them difficult or impossible to manufacture in a practical way using traditional fabrication techniques such as extrusion. Hence, various fin inserts described below are preferably designed using a shape optimization tool that provides both (i) a more accurate representation of the system geometry since interfaces are clearly defined, and (ii) more control on the shape of the optimal designs by enabling local exploration of the design space.

In some approaches, two dimensional layouts of the insert designs are obtained using a systematic shape optimization process that realizes designs with clearly defined interfaces and reaches an optimal solution by explicitly updating the discretized geometry of the system. The physical analysis of the system may be computed using response functions derived from experimental data, geometry of design domain, manufacturability and operating temperature constraints.

Accordingly, while many of the same parameters, materials, diameters, etc. as presented above may be used in various fin inserts described below, the fin insert designs below are also designed to allow easier and more consistent and reliable manufacturing, especially when extrusion is used as the formation technique.

The fin insert designs described below are shape-optimized fin inserts that may be used for thermo-catalytic reactions, which occur in various classes of energy systems, including Fischer-Tropsch reactors. Various approaches of the optimal fin inserts provide appropriate conductive pathways in a catalyst matrix to achieve better heat management (and thus, better performance). The fin inserts are preferably made of aluminum or other high-thermal-conductivity material with the dimensions specified elsewhere herein. A catalyst matrix may be positioned between the features of the fin inserts as well as between the fin inserts and the reactor shell. These designs can be used for all types of Fischer-Tropsch reactors, and may also be used for other porous reactors where heat management is important. The fin insert designs may be obtained by optimizing performance via varying the number and/or geometry of fin inserts, as described below.

The shape optimization approach employed in at least some aspects of the present invention is a version of a “node coordinate aware” (also known as “parameter free”) methodology in which the coordinates of the mesh nodes in the discretized system are defined as the control variables of the optimization problem. This is in stark contrast to the techniques above that use density-based topology optimization and parameterized shape projection optimization from a methodology standpoint. The employed shape optimization approach for the designs below is superior to the former methodology, because it can provide a crisp definition of the geometry (e.g., topology optimized designs are defined by a diffused fictitious density field), while providing a relatively large design space to explore (compared to the parametrized shape optimization tested before that could only update a few parameters of constructive solid geometries, which was significantly limiting).

Note too that the domain size of this new set of designs is different from the ones obtained above. Also, the external pipe (e.g., reactor shell) is not simulated in the analysis. The problem formulation used to obtain the designs below include maximizing the heat generated in the system (as a proxy for fuel production) while keeping the maximum temperature under a threshold.

### Exemplary Fin Inserts

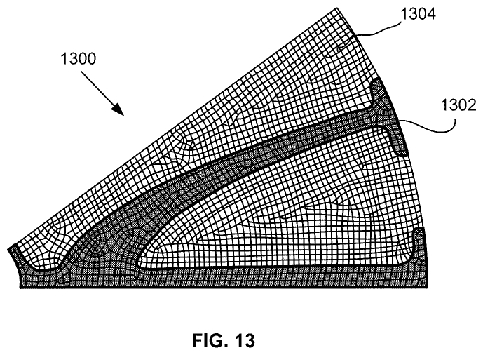

FIG. 9 depicts a heat conducting fin insert 900 for a reactor, in accordance with one approach. As an option, the present fin insert 900 may be implemented in conjunction with features from any other approach listed herein, such as those described with reference to the other FIGS. Of course, however, such fin insert 900 and others presented herein may be used in various applications and/or in permutations which may or may not be specifically described in the illustrative approaches listed herein. Further, the fin insert 900 presented herein may be used in any desired environment.

As shown, the fin insert 900 (also referred to herein a simply “fin” or “insert” or “heat conducting insert”) includes a center portion 902, and a cross member 904 extending outwardly from the center portion 902 in a radial direction 906. At least two branches 908 extend outwardly from the cross member 904 and away from the center portion 902. Each of the branches 908 has an outer portion 910 extending laterally from a distal end of the respective branch 908 along a portion of an imaginary semicircle 912 (e.g., half circle) approximating the inner surface of a tube (shell) of a reactor. Said another way, the outer portion 910 may have a curvature approximating an inner surface of a portion of a reactor for which the fin insert 900 is designed.

Preferably, the foregoing set of components, namely the center portion 902, the cross member 904, the branches 908, and the outer portions 910, is part of a monolithic, extruded structure. In some aspects, the monolithic structure may have only one center portion 902, one cross member 904, one outer portion 910, and the branches 908. Thus, in one approach, a configuration may have five separate fin inserts 900 of the type shown in FIG. 9, each fin insert 900 having one set of the foregoing components. In other aspects, a single monolithic structure may have several sets of the foregoing components. Thus, one approach has a single fin insert 900 having many of the foregoing sets of components, e.g., several center portions 902 that together form a ring, with cross members 904 extending therefrom and branches 908 extending from the cross members 904. In yet other approaches, a configuration may have two fin inserts 900 having many of the foregoing sets of components, three fin inserts 900, four fin inserts 900, and so on.

In some approaches, a plurality of cross members 904 extend outwardly from adjacent center portions 902 (e.g., a plurality of discrete center portions positioned together; or a larger, continuous center piece that may be ring-like, tube-like, etc. and having the cross members extending therefrom), each cross member 904 having respective branches 908 extending outwardly therefrom. Preferably, the cross members have substantially the same cross sectional profile.

Thus, while five sets of components that together form one or more fin inserts 900 are shown in the configuration of FIG. 9, various aspects may have a different number of sets of components. For example, some approaches may have two sets of components (e.g., one fin insert 900 having both sets of components, or two fin inserts 900 each having one set of components). Other approaches may have three sets of components, four sets of components, six sets of components, or more.

Each branch 908 may have any desired shape, location, thickness profile, curvature, etc. but preferably such parameters are optimized according to the methodology presented elsewhere herein, e.g., as determined via the methodology presented below. Moreover, it is preferred that the branches 908 extending from a given cross member 904 are symmetrical about the cross member 904, thus having substantially the same cross sectional profile, e.g., as shown in FIG. 9.

In a preferred approach, a width of each branch 908 decreases therealong toward its outer portion 910, as shown.

In some approaches, the cross member 904 does not extend to the imaginary semicircle. For example, the length of the cross member 904 may be between about 20% and about 80% of a distance between the center portion 902 and the imaginary semicircle 912.

FIG. 9 of U.S. Provisional Patent Application No. 63/545,326 shows a modeled temperature distribution profile during a typical Fischer-Tropsch reaction, demonstrating the thermal transport effect of the fin insert 900.

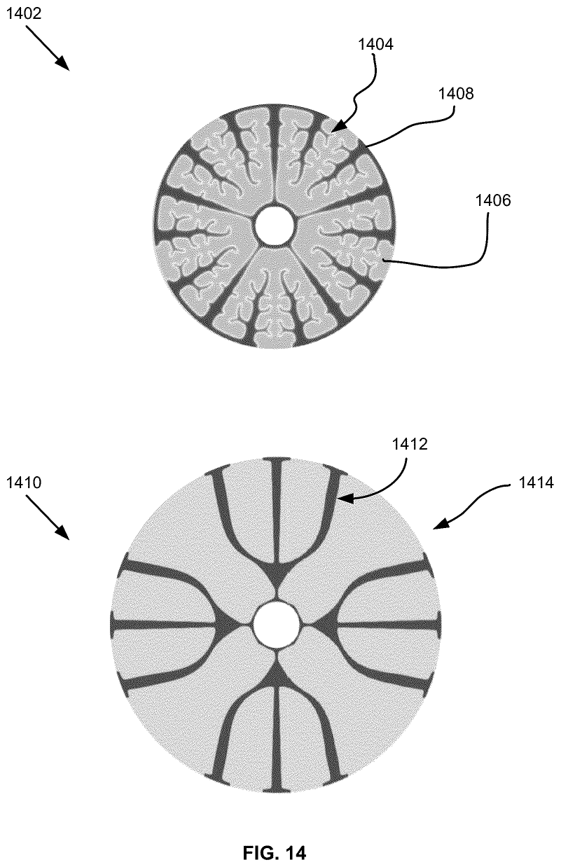

FIG. 10 depicts a heat conducting fin insert 1000 for a reactor, in accordance with one approach. As an option, the present fin insert 1000 may be implemented in conjunction with features from any other approach listed herein, such as those described with reference to the other FIGS. Of course, however, such fin insert 1000 and others presented herein may be used in various applications and/or in permutations which may or may not be specifically described in the illustrative approaches listed herein. Further, the fin insert 1000 presented herein may be used in any desired environment.

As shown, the fin insert 1000 includes a center portion 1002, and a cross member 1004 extending outwardly from the center portion 1002 in a radial direction 1006. At least two branches 1008 extend outwardly from the cross member 1004 and away from the center portion 1002. Each of the branches 1008 has an outer portion 1010 extending laterally from a distal end of the respective branch 1008 along a portion of an imaginary semicircle 1012 (e.g., half circle) approximating the inner surface of a tube of a reactor.

Preferably, the foregoing set of, components, namely the center portion 1002, the cross member 1004, the branches 1008, and the outer portion 1010, is part of a monolithic, extruded structure. In some aspects, the monolithic structure may have only one center portion 1002, one cross member 1004, one outer portion 1010, and the branches 1008. Thus, in one approach, the configuration shown in FIG. 10 has five separate fin inserts 1000, each fin insert 1000 having one set of the foregoing components. In other aspects, a single monolithic structure may have several sets of the foregoing components. Thus, in one approach, the configuration shown in FIG. 10 may have one single fin insert 1000 having many of the foregoing sets of components, e.g., several center portions 1002 that together form a ring or are part of a continuous ring, with cross members 1004 extending therefrom. In yet other approaches, the configuration shown in FIG. 10 may have two fin inserts 1000 having many of the foregoing sets of components, three fin inserts 1000, and so on.

In some approaches, a plurality of cross members 1004 extend outwardly from adjacent center portions 1002 in a symmetrical manner, each cross member 1004 having respective branches 1008 extending outwardly therefrom. Preferably, the cross members have substantially the same cross sectional profile.

Thus, while five sets of components that together form one or more fin inserts 1000 are shown in the configuration of FIG. 10, various aspects may have a different number of sets of components. For example, some approaches may have two sets of components (e.g., one fin insert 1000 having both sets of components, or two fin inserts 1000 each having one set of components). Other approaches may have three sets of components, four sets of components, six sets of components, or more.

Each branch 1008 may have any desired shape, location, thickness profile, curvature, etc. but preferably such parameters are optimized according to the methodology presented elsewhere herein, e.g., as determined via the methodology presented below. Moreover, it is preferred that the branches 1008 extending from a given cross member 1004 are symmetrical about the cross member 1004, thus having substantially the same cross sectional profile, e.g., as shown in FIG. 10.

In a preferred approach, a width of each of the branches 1008 decreases from the cross member toward a center region 1016 of the branch, and then increases from near the center region 1016 toward the distal end of the respective branch 1008.

Also, the cross member 1004 may have an outer portion 1014 that extends along a portion of the imaginary semicircle 1112.

FIG. 10 of U.S. Provisional Patent Application No. 63/545,326 shows a modeled temperature distribution profile during a typical Fischer-Tropsch reaction, demonstrating the thermal transport effect of the fin insert 1000.

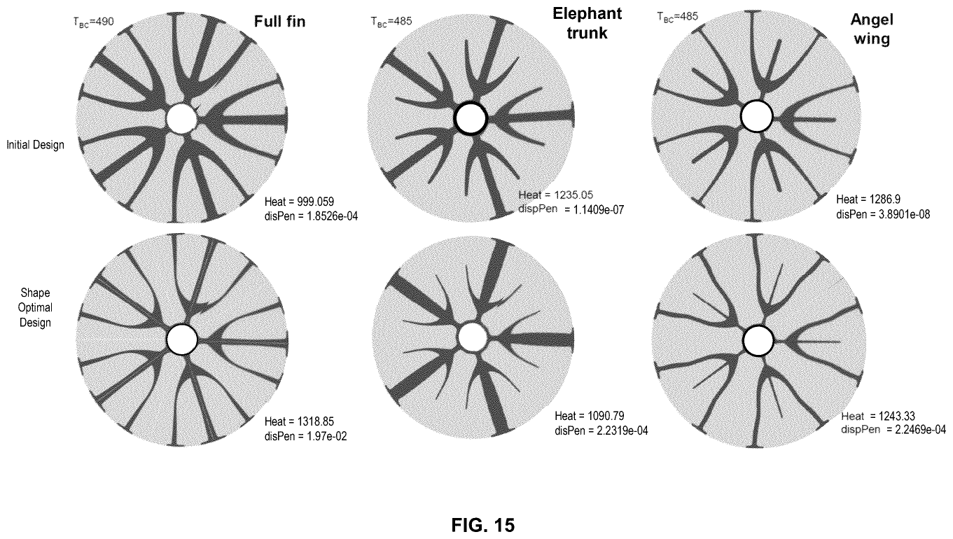

FIG. 11 depicts a heat conducting fin insert 1100 for a reactor, in accordance with one approach. As an option, the present fin insert 1100 may be implemented in conjunction with features from any other approach listed herein, such as those described with reference to the other FIGS. Of course, however, such fin insert 1100 and others presented herein may be used in various applications and/or in permutations which may or may not be specifically described in the illustrative approaches listed herein. Further, the fin insert 1100 presented herein may be used in any desired environment.

As shown, the fin insert 1100 includes a center portion 1102, and a cross member 1104 extending outwardly from the center portion 1102 in a radial direction 1106.

An outer portion 1110 extends laterally from a distal end of the cross member 1104 along a portion of an imaginary semicircle 1112 (e.g., half circle, or portion of a whole circle approximating the inner surface of a tube of a reactor).

At least two branches 1108 extend outwardly from the cross member 1104 from a location on the cross member 1104 located between the center portion 1102 and the outer portion 1110. The branches 1108 extend away from each other and toward the imaginary semicircle 1112, but distal ends 1114 of the branches do not extend to the semicircle 1112.

Preferably, the foregoing set of components, namely the center portion 1102, the cross member 1104, the outer portion 1110, and the branches 1108, are part of a monolithic, extruded structure. In some aspects, the monolithic structure may have only one center portion 1102, one cross member 1104, one outer portion 1110, and the branches 1108. Thus, in one approach, the configuration shown in FIG. 11 has eight separate fin inserts 1100, each fin insert 1100 having one set of the foregoing components. In other aspects, a single monolithic structure may have several sets of the foregoing components. Thus, in one approach, the configuration shown in FIG. 11 may have one single fin insert 1100 having many of the foregoing sets of components, e.g., several center portions 1102 that together form a ring, with cross members 1104 extending therefrom. In yet other approaches, the configuration shown in FIG. 11 may have two fin inserts 1100 having many of the foregoing sets of components, three fin inserts 1100, and so on.

In some approaches, a plurality of cross members 1104 extend outwardly from adjacent center portions 1102, each cross member 1104 having respective branches 1108 extending outwardly therefrom. Preferably, the cross members have substantially the same cross sectional profile with respect to one another. Thus, while eight sets of components that together form one or more fin inserts 1100 are shown in the configuration of FIG. 11, various aspects may have a different number of sets of components. For example, some approaches may have two sets of components (e.g., one fin insert 1100 having both sets of components, or two fin inserts 1100 each having one set of components). Other approaches may have three sets of components, four sets of components, six sets of components, or more.

Each branch 1108 may have any desired shape, location, thickness profile, curvature, etc. but preferably such parameters are optimized according to the methodology presented elsewhere herein, e.g., as determined via the methodology presented below. Moreover, it is preferred that the branches 1108 extending from a given cross member 1104 are symmetrical about the cross member 1104, thus having substantially the same cross sectional profile, e.g., as shown in FIG. 11.

In preferred aspects, a width of each branch 1108 decreases therealong toward the distal end 1114 thereof. One such approach is shown in FIG. 11.

Also note that in some approaches, the branches 1108 do not extend to the imaginary semicircle 1112. For example, the length of each branch 1108 from the cross member 1104 to the distal end 1114 of the branch 1108 may be between about 20% and about 80% of the length of the cross member 1104 from the center portion 1102 to the imaginary semicircle 1112. In other approaches, the length of each branch is between about 20% and about 50% of the length of the cross member 1104. In yet other approaches, the length of each branch is between about 50% and about 80% of the length of the cross member 1104.

FIG. 11 of U.S. Provisional Patent Application No. 63/545,326 shows a modeled temperature distribution profile during a typical Fischer-Tropsch reaction, demonstrating the thermal transport effect of the fin insert 1100.

In various aspects, any of the fin inserts described herein may have a center portion that is resiliently deformable, such that the center portion is configured to reversibly compress for reducing a circumference of the fin insert.

In various aspects, any of the fin inserts described herein may have a center portion that is continuous along a longitudinal length thereof in a direction parallel to the longitudinal axis of the reactor (e.g., a direction into the page of FIGS. 9, 10 and 11).

In various aspects, any of the fin inserts described herein may have a center portion that is not continuous along the longitudinal length thereof. For example, several fin inserts that are shorter than the inner longitudinal length of the reactor may be stacked one atop the other in the reactor.

In various aspects, any of the fin inserts described herein may have an outer portion (of the cross member and/or wings) that does not form a continuous perimeter along the imaginary semicircles that approximate the inner surface of the reactor (see e.g., tube 252 of FIGS. 2D and 2E, which extends along imaginary semicircles). Rather, in such aspects, the outer portions have shorter lengths along the imaginary semicircle to allow heat of reaction to escape directly to the tube 252, while having a length calculated to transfer a large amount of heat from the cross member to said tube. Exemplary lengths of the outer portions are in a range of less than about 1/10 of the circumference of the reactor, preferably less than about 1/20 of the circumference of the reactor.

Note that the reactor inner shell diameter for a Fischer-Tropsch reaction is approximately 20 (±5) mm for a steel or stainless steel shell wall without any internal thermal management. With the fin inserts disclosed herein, the internal diameter may be enlarged significantly. For example, for Fischer-Tropsch reactions with the presently-described fin inserts in use, the diameter may be in a range of about 1 inch to about 6 inches, preferably about 1.6 to about 5 inches, and ideally about 3 to about 4 inches. Modeling has shown excellent thermal conductivity using the fin inserts in a 1.9 inch inner diameter schedule 10 steel pipe, as well as in a 4.26 inner diameter schedule 120 steel pipe. The shell wall may be of conventional thickness, materials, etc.

The fin inserts described herein may be constructed of any suitable material. Preferably, the material is compatible with the process so that it does not significantly deteriorate or disintegrate during use.

The fin insert material preferably has a thermal conductivity that is at least five times higher than the thermal conductivity of the catalyst. As an example, the thermal conductivity of a typical catalyst for a Fischer-Tropsch reaction is about 0.2 W/m·K. Preferably, the thermal conductivity of the fin insert material is greater than ten times the thermal conductivity of the catalyst, more preferably at least 20 times higher. In some approaches, the thermal conductivity of the fin insert material is at least 100 times higher than the thermal conductivity of the catalyst, in yet other approaches at least 1000 times higher.

Preferably, the material from which the fin insert is constructed is extrudable. Exemplary materials include aluminum (thermal conductivity of about 600 W/m·K), copper (thermal conductivity of about 383 W/m·K), silver (thermal conductivity of about 505 W/m·K), gold, alloys, etc.

In further approaches, the fin inserts may be formed by another technique, such as casting, additive manufacturing such as printing, powder metallurgy, machining, etc. For example, stainless steel is not particularly amenable to extrusion, but can be formed into a fin insert via one or more of these techniques.

In further approaches, the material from which the fin insert is constructed may be a nonmetal. Examples of such materials include silicon carbide (thermal conductivity of about 120 W/m·K), boron nitride (thermal conductivity of about 71 W/m·K), ceramics, etc.

A reactor according to various aspects includes a shell as described elsewhere herein. One or more of the heat conducting fin inserts described herein are positioned in the shell. Such reactor may have any of the features described elsewhere herein, e.g., see the description of FIGS. 2D and 2E. For example, the insert may be press-fitted into the shell. Moreover, a catalyst matrix may be present in the shell, and the catalyst extends along the insert. The shell may encompass the insert and the catalyst matrix.

### Fin Insert Design

An illustrative methodology for designing fin inserts will now be described.

The shape optimization approach employed in at least some aspects of the present invention is a version of a “node coordinate aware,” “parameter free” methodology in which the coordinates of mesh nodes in the discretized system are defined as the control variables of the optimization problem. This is in stark contrast to the techniques above that use topology optimization and parameterized shape optimization from a methodology standpoint. The employed shape optimization approach for the designs in FIGS. 9-11 and the designs below is superior to the former methodology, because it can provide a crisp definition of the geometry (e.g., topology optimized designs are defined by a diffused fictitious density field), while providing a relatively large design space to explore (compared to the parametrized shape optimization tested before that could only update a few parameters of constructive solid geometries, which was significantly limiting). From a formulation standpoint, this approach may require the computation of shape sensitivities, which implies the need for additional complex operations to obtain accurate gradients.

Note too that the domain size of the new set of designs in the immediately preceding section (see FIGS. 9-11) is different from the ones obtained earlier.

The process begins by selecting a practical initial geometry of the fin insert.

Various physical characteristics of the fin insert are selected, such as material for the fin insert, diameter of the tubes that define the reactor chamber in which the fin will be inserted, manufacturability constraints such as minimum wall thickness for successful extrusion, etc. Any of the parameters used in the methodology presented several sections above may be included as well.

A preliminary analysis, and simple design problems, may be run such that the optimization of algorithmic parameters are tuned to make the optimization problem well-posed. For example, parameters in the equations may be tuned to avoid mesh tangling, in a manner that would become apparent to one skilled in the art after reading the present disclosure.

Once the algorithmic parameters are tuned, a larger problem with a finer mesh is used. The coordinates of mesh nodes in the discretized system are defined as the control variables of the optimization problem. The problem formulation used to obtain the new designs includes maximizing the heat generated in the system (as a proxy for fuel production) while keeping the maximum temperature under a threshold. Also, in some approaches, the external shell is not simulated in the analysis.

The larger problem may use any equations, computations, etc. that would become apparent to one skilled in the art after reading the present disclosure. Known equations may be used.

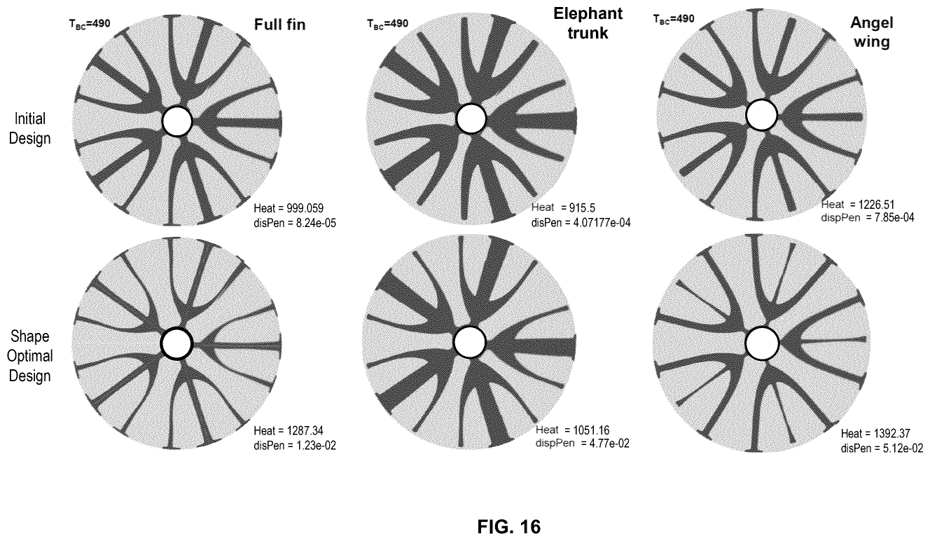

FIG. 12 is a conceptual graph 1200 representing a shape optimization problem according to one exemplary approach. The objective, J, includes a second (penalty) term that is used to control the shape morphing in the optimization and thus, a well-posed formulation.

Manufacturability constraints may be included by locally limiting the node movement of the designs in certain regions of the design domain. Thus, the manufacturability constraints may be enforced by limiting movement of the mesh.

In one approach, the highly exothermic, temperature-dependent reactions in the fuel synthesis of Fischer-Tropsch reactors are simulated using a heat transfer model with an Arrhenius temperature dependence in the volumetric heat generation field. A two-dimensional setup is preferred where the reactor inserts are to be produced through extrusion.

Material properties and nonlinear behavior of the modeled system may be characterized from experimental data obtained by routine experimentation using prototypes or existing Fischer-Tropsch systems.

In some approaches, the thermal response (e.g., the heat generated in the reactor for a given set of conditions) is predicted using a standard finite element method (as opposed to a finite volume based approach as in the previous method described above). While any known technique can be used, preferred aspects use Serac Code from Lawrence Livermore National Security, LLC having a place of business at 7000 East Ave, Livermore, CA 94550.

Serac is a 3D implicit nonlinear thermal-structural simulation code produced at Lawrence Livermore National Laboratory (LLNL). Its primary purpose is to investigate multiphysics abstraction strategies and implicit finite element-based algorithm development for emerging computing architectures. Serac heavily leverages the MFEM finite element library. MFEM is a free, lightweight, scalable C++ library for finite element methods. Access to MFEM can be obtained from LLNS or MFEM.org.

Note that the influence of the outer pipe (shell) on the solution to the problem is not as pronounced as the previous method, especially where heat transfer by boiling water on the outside of the pipe and higher thermal conductivity than the catalyst can be assumed, and thus the inner temperature of the pipe can be assumed to be very close to the outer temperature. Accordingly, a fixed temperature at the outer boundary may be used when computing the problem, instead of adding characteristics of the pipe and associated algorithmic parameters to the computation. This simplifies the computation in some respects. Note, however, that in other approaches, the thermal effects of the outer pipe may be considered in the computation.

The surface interface of the fin insert with the catalyst is changed to optimize the shape of the components of the fin insert. For instance, the mesh is morphed. This approach is different than the previous methodology in that the present method uses shape optimization rather than topology optimization. Particularly, the present method explicitly uses shape optimization with a clearly defined interface between materials via conformal meshes.

Various methods for shape optimization may be used in various approaches, as would become apparent to one skilled in the art after reading the present disclosure. In one approach, shape derivatives are used for shape optimization.

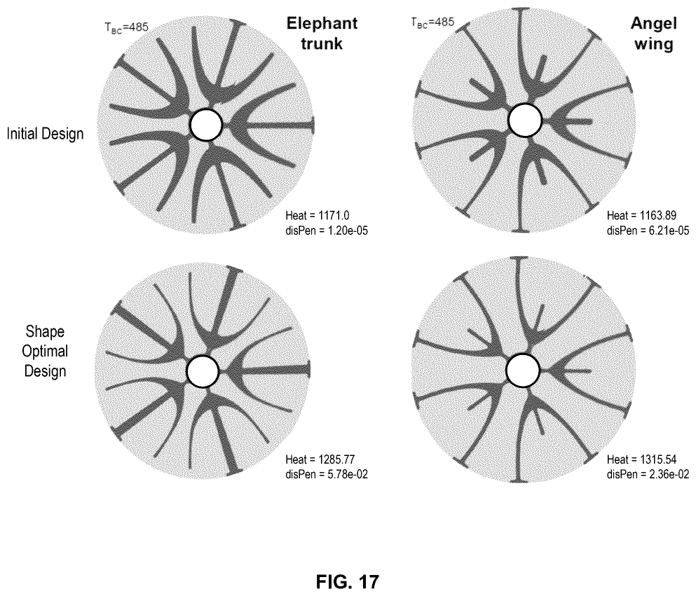

For example, a mesh may be generated to define the interface between materials, e.g., the interface between the fin insert and the catalyst. Thus, a mesh may be created for the initial design of a fin insert for the associated problem, as well as for the catalyst adjacent the fin insert. As shown in FIG. 13, the mesh 1300 includes two phases, defined element-wise, within the fin insert 1302 and the catalyst 1304. During problem setup, the size of the nodes may be optimized to provide good node definition while minimizing distortion of the nodes.

The mesh may then be morphed based on the algorithmic parameters, characteristics of the fin insert, thermal profile, etc. to iterate toward an optimum design. In other words, various nodes of the mesh are moved to gradually improve the heat transfer within the fin insert. For example, the mesh may be morphed at each stage in the optimization.

The high definition of the interface between the fin insert and the catalyst as defined by the mesh allows precise modeling of the heat transfer from the catalyst to the fin insert. Thus, the accuracy of the simulation is much improved.

Movement of nodes in the mesh may be constrained for various purposes, e.g., to avoid defining of very fine features that might render the fin insert impractical for manufacturing e.g., via extrusion.

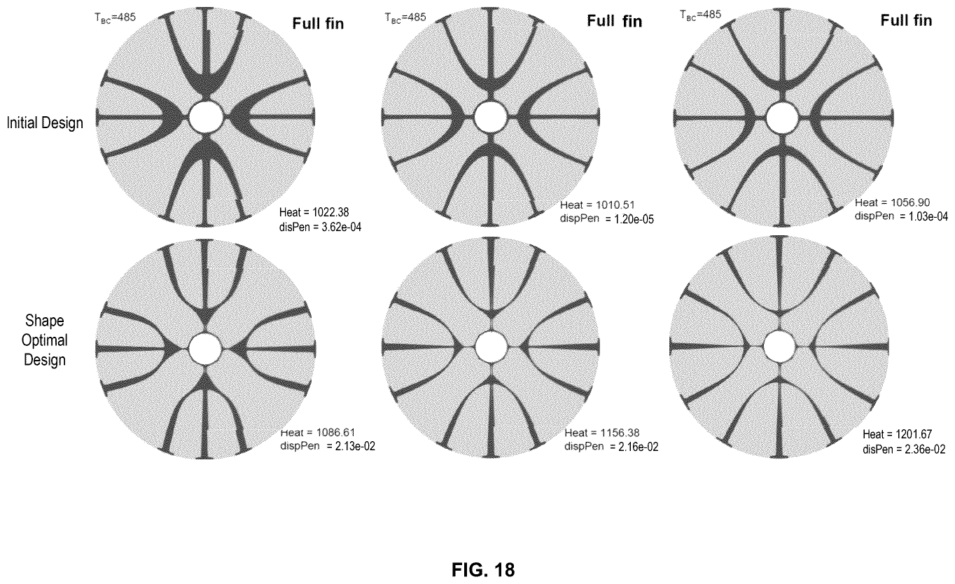

Use of the mesh provides a clear interface between materials for the process to analyze, thereby greatly increasing the estimation of heat transfer. FIG. 14 illustrates this distinction from previous processes, where the interface between materials was not well-defined in such previous processes. As shown, in a model 1402 from an earlier process, the interface 1404 between the catalyst 1406 and fin insert 1408 is fuzzy, and was not well defined. Thus, the “intermediate” region at the interface 1404 resulted in a less precise solution. In the new model 1410, the interface 1412 is very well defined, as viewed by the process. Moreover, in the new model 1410, the temperature profile is nonlinear, as exemplified in the thermal profile shown in FIG. 14 of U.S. Provisional Patent Application No. 63/545,326, where the darker the color, the cooler it is. More bright regions (hotter) are better, in that those regions have a higher rate of reaction.

### Modeling Examples

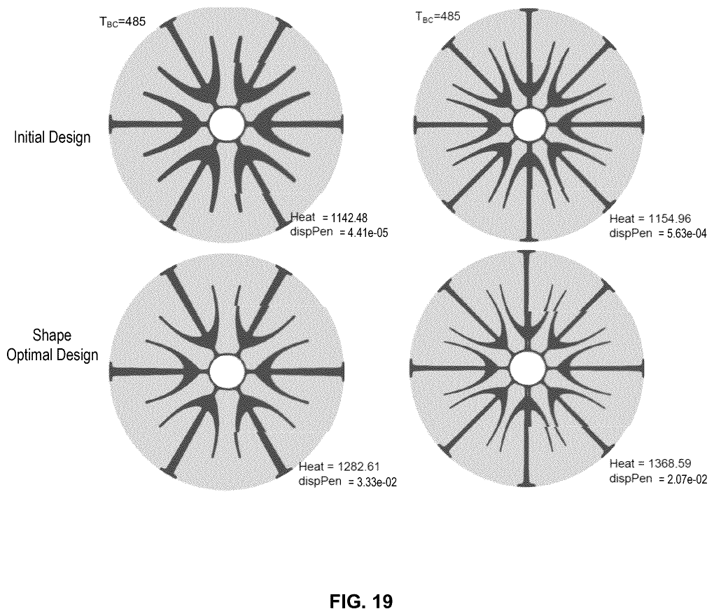

FIG. 15 depicts a first round of results for three unique initial designs for fin inserts, using the new methodology presented herein. The top image in each column shows the initial design, and the bottom image in each column shows the shape optimized design. Note that a thermal profile for each of these designs is shown in FIG. 15 of U.S. Provisional Patent Application No. 63/545,326. The objective of this round was to tune algorithm parameters. Note the different prescribed temperature for the initial design on the left. Less material than the minimum to keep the fins was needed to get to a temperature close to the maximum in that case (this is explored later in the fourth group of results).

FIG. 16 depicts a second round of results for three initial designs for fin inserts. The top image in each column shows the initial design, and the bottom image in each column shows the shape optimized design. Note that a thermal profile for each of these designs is shown in FIG. 16 of U.S. Provisional Patent Application No. 63/545,326. All cases here had a maximum temperature of 490K and displacement penalties within an acceptable range.

FIG. 17 depicts a third round of results for three initial designs for fin inserts. The top image in each column shows the initial design, and the bottom image in each column shows the shape optimized design. Note that a thermal profile for each of these designs is shown in FIG. 17 of U.S. Provisional Patent Application No. 63/545,326. In this case, the configurations found on the left of FIGS. 15-16 were not feasible, i.e., it could not reach the maximum temperature without incurring topological changes.

FIG. 18 depicts a fourth round of results for three initial designs for fin inserts. The top image in each column shows the initial design, and the bottom image in each column shows the shape optimized design. Note that a thermal profile for each of these designs is shown in FIG. 18 of U.S. Provisional Patent Application No. 63/545,326. In this round, four-fin initial designs were used.

FIG. 19 depicts a fifth round of results for two initial designs for fin inserts, basically having the same shape but with more inserts in the example in the right column. The top image in each column shows the initial design, and the bottom image in each column shows the shape optimized design. Note that a thermal profile for each of these designs is shown in FIG. 19 of U.S. Provisional Patent Application No. 63/545,326. This round demonstrates the effect of having more fin inserts. Note the thinner features in the column to the right.

Note that FIGS. 9-11 depict the best results for each configuration discussed in this section.

### IN USE

Various aspects of the present disclosure improve upon the performance of tubular Fischer-Tropsch reactors. At least some of the aspects as described herein may be used with thermo-catalytic reactors, as would become apparent to one having ordinary skill in the art upon reading the present disclosure. In other approaches, at least some aspects as described herein may be used with other porous reactors.

The inventive concepts disclosed herein have been presented by way of example to illustrate the myriad features thereof in a plurality of illustrative scenarios, aspects, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of the present invention have been described above, it should be understood that they have been presented by way of example only, and not limitation. Thus, the breadth and scope of an aspect of the present invention should not be limited by any of the above-described exemplary approaches, but should be defined only in accordance with the following claims and their equivalents.

What is claimed is:

1. A heat conducting insert for a reactor, the insert comprising:
a center portion;
a cross member extending outwardly from the center portion in a radial direction; and
at least two branches extending outwardly from the cross member and away from the center portion,
each of the branches having an outer portion extending laterally from a distal end of the respective branch along a portion of an imaginary semicircle.

2. The insert of claim 1, wherein the center portion, the cross member, the outer portion, and the branches are part of a monolithic, extruded structure.

3. The insert of claim 1, wherein a width of each branch decreases therealong toward the outer portion thereof.

4. The insert of claim 1, wherein the cross member does not extend to the imaginary semicircle.

5. The insert of claim 1, wherein a length of the cross member is between about 20% and about 80% of a distance between the center portion and the imaginary semicircle.

6. The insert of claim 1, wherein widths of at least some of the branches decrease therealong from the respective cross member toward a center region of the respective branch and then increase therealong from the center region toward the distal end of the respective branch.

7. The insert of claim 1, wherein a plurality of cross members extend outwardly from adjacent center portions in a symmetrical manner, each cross member having respective branches extending outwardly therefrom.

8. The insert of claim 7, wherein the cross members have substantially the same cross sectional profile.

9. A heat conducting insert for a reactor, the insert comprising:
a center portion;
a cross member extending outwardly from the center portion in a radial direction;
an outer portion extending laterally from a distal end of the cross member along a portion of an imaginary semicircle; and
at least two branches extending outwardly from the cross member from a location on the cross member located between the center portion and the outer portion, the branches extending away from each other and toward the imaginary semicircle, wherein distal ends of the branches do not extend to the semicircle.

10. The insert of claim 9, wherein the center portion, the cross member, the outer portion, and the branches are part of a monolithic, extruded structure.

11. The insert of claim 9, wherein a width of each branch decreases therealong toward a distal end thereof.

12. The insert of claim 9, wherein a length of each branch measured from the cross member to the distal end thereof is between about 20% and about 80% of a length of the cross member measured from the center portion to the outer portion.

13. The insert of claim 9, wherein a plurality of cross members extend outwardly from the center portion in a symmetrical manner, each cross member having a respective outer portion extending therefrom and branches extending outwardly therefrom.

14. The insert of claim 13, wherein the cross members have substantially the same cross sectional profile.

15. The insert of claim 13, wherein the center portion is resiliently deformable, wherein the center portion is configured to reversibly compress for reducing a circumference of the insert.

16. A reactor, comprising:
a shell; and
the insert of claim 1, the insert being positioned in the shell.

17. The reactor of claim 16, comprising a catalyst matrix in the shell and extending along the insert.

18. The reactor of claim 17, wherein the shell encompasses the insert and the catalyst matrix.

19. The reactor of claim 16, wherein the center portion is continuous along a longitudinal length thereof in a direction parallel to the longitudinal axis of the shell.

20. A method for designing a heat conducting insert for a reactor, the method comprising:
selecting an initial geometry of an insert;
defining physical characteristics of the insert;
selecting algorithmic parameters for use in optimizing the insert geometry;
generating a mesh representing the insert in the initial geometry; and
morphing the mesh in an iterative process that considers the physical characteristics of the insert to optimize heat transfer provided by the insert.
